(19) United States
(12) Patent Application Publication
(10) Pub. No.: US 2008/0231905 A1
(43) Pub. Date: Sep. 25, 2008

(54) METHOD FOR CALCULATING INK-JET PRINTING DATA

(75) Inventors: Chih-Hsuan Chiu, Taipei County (TW); Chao-Kai Cheng, Miaoli County (TW); Wan-Wen Chiu, Hsinchu County (TW); Ming-Huan Yang, Taichung County (TW); Chih-Jian Lin, Taipei County (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, HSINCHU (TW)

(21) Appl. No.: 12/050,630

(22) Filed: Mar. 18, 2008

(30) Foreign Application Priority Data
Mar. 21, 2007 (TW) TW96109727

(51) Int. Cl. G06T 5/00; H04N 1/409; G06K 15/00

(52) U.S. Cl. 358/3.27; 358/1.9

(57) ABSTRACT

A method for calculating ink-jet printing data is disclosed. A preset pattern is first obtained. Ink-jet points required for the preset pattern are calculated to select a filtering mode. A filtering operation is implemented on the preset pattern according to the filtering mode, resulting in an applicable number of ink-jet points for the preset pattern. The preset pattern is printed on a base board based on the resulting ink-jet points.

### BACKGROUND OF THE INVENTION

1. Field of the Invention

The invention relates to data calculation, and more particularly to a method for calculating ink-jet printing data.

2. Description of the Related Art

A printed circuit board (PCB) is a connected and conducted circuit board and is an inserted or an installed electronic component. Assembled electronic components and circuit designs perform functions of electronic products. A PCB is an indispensable basic part in manufacturing of all electronic products.

A PCB is important for the electronic information industry, and is widely applied to information products, communication products, consumer electronic products, industrial electronic products, and the like. Generally, a PCB manufacturing process extends and electroplates copper foil and coats a photoresist layer on a base board with mask exposure, development, and etching to form a metal line. An insulating base board is bonded, drilled, and electroplated and outer metal lines are etched to form a multi-layered circuit board. The multi-layered circuit board is processed with anti-welding, metal surface treatment, forming, and dependence inspection to complete the manufacturing process.

When a circuit with metal lead wires is produced by printing, the size of a liquid-drop printed on a base board is feedback to adjust printing data. When the printing quality, however, is improved to enhance the printing resolution, more liquid-drops are printed in a printing location with smaller area, resulting in an overflow for a greater amount of liquid-drops.

Additionally, either precision of printing patterns or a distributed amount for distributed material (i.e. controlling a formed thickness on the base board for a distributed material) are requested by printing results for printing technology relating to industrial applications. Meanwhile, a preset material distribution amount should be uniformly coated within a specified area, especially for liquid coating. Furthermore, overflow may occur due to excessive thickness (huge flow) of diffusive material.

Thus, the invention provides a method for calculating ink-jet printing data, adjusting film thickness while pattern data is transformed to printed data, so that ink-jet overflow relating to a printing result does not occur and a printing shape may correspond to an original pattern.

### BRIEF SUMMARY OF THE INVENTION

The invention provides methods for calculating ink-jet printing data. An exemplary embodiment of a method for calculating ink-jet printing data comprises the following. A preset pattern is first obtained. Ink-jet points required for the preset pattern are calculated to select a filtering mode. A filtering operation is implemented on the preset pattern according to the filtering mode, resulting in an applicable number of ink-jet points for the preset pattern. The preset pattern is printed on a base board based on the resulting ink-jet points.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIGS. 1A and 1B are schematic views of filtering modes of the present invention;

FIGS. 2A-2C are schematic views of edge filtering processes of the present invention;

FIGS. 3A-3C are schematic views of edge filtering modes and characteristic items of the present invention;

FIG. 4 is a schematic views of circular filtering with different dimensions;

FIGS. 5 and 6 respectively illustrate the original pattern and filtered results;

FIGS. 7-11 illustrate differences for different filtering modes based on experimental results;

FIG. 12 illustrates an example of a liquid crystal coating area, achieving precise control of the amount of liquid crystal coating;

FIG. 13 illustrates an example of a liquid crystal coating;

FIG. 14 illustrates a resulting pattern by a program operation, in which data required for the operation is set as described;

FIG. 15 is a flowchart of liquid crystal coating shown in FIGS. 12-14 of the present invention; and

FIG. 16 is a flowchart of printing data calculation of the present invention.

### DETAILED DESCRIPTION OF THE INVENTION

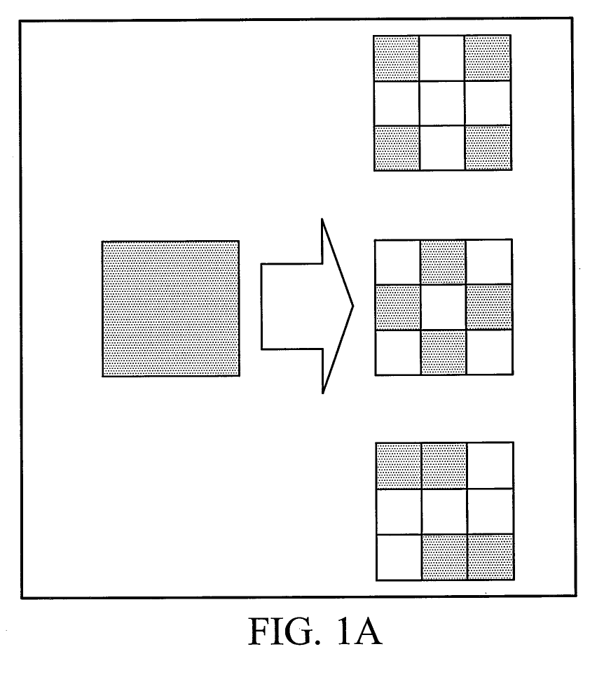

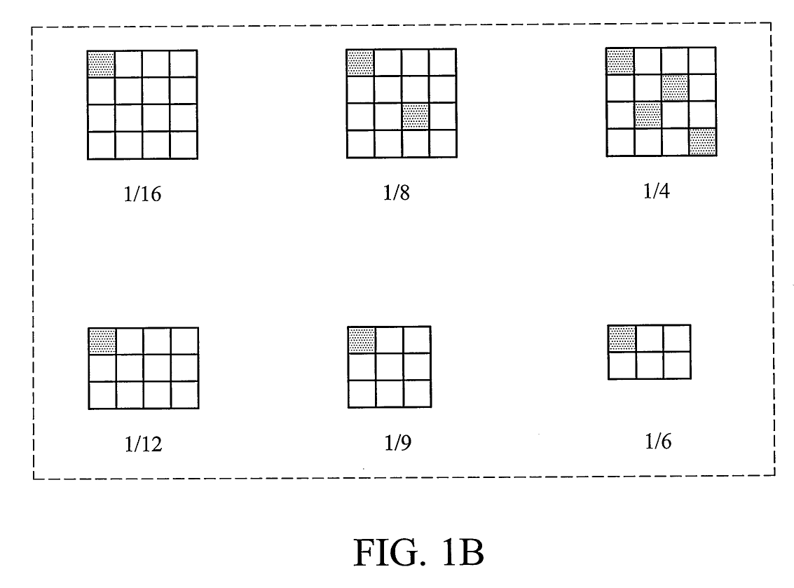

Several exemplary embodiments of the invention are described with reference to FIGS. 1 through 16, which generally relate to calculation of ink-jet printing data. It is to be understood that the following disclosure provides various different embodiments as examples for implementing different features of the invention. Specific examples of components and arrangements are described in the following to simplify the present disclosure. These are merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

The invention discloses a method for calculating ink-jet printing data that controls printing thicknesses and enhances printing quality. Thus, the method of the invention can control pattern fineness and thicknesses of distributed material.

Original printing data applied for an embodiment of the method for calculating ink-jet printing data comes from a preset pattern. Meanwhile, a preset printing resolution represents that the preset pattern is sampled to generate printing data and a sampling rate thereof represents a preset resolution. When a two inched square pattern, for example, is printed by 400 dot per inches (dpi), printing data is sampled by 800×800 sizes, and 1200×1200 sizes with 600 dpi. That is to say, when a printed pattern occupies 60% of the two inched square pattern, 800×800×60%=384000 liquid-drops with 400 dpi are coated on the printed pattern with the same area while 1200×1200×60%=864000 liquid-drops with 600 dpi are coated on the printed pattern with the same area.

Regardless of film thickness and ink material with low fluidity, the non-industrial printed pattern looks, to the average eye, similar. However, film thickness must be considered and controlled and characteristic variation of ink material is great when applied in industrial applications. Specifically, problems occur if the printed pattern is only re-sampled to be directly transformed to the printed data. Thus, for the present invention, if the 864000 liquid-drops for the 1200 dpi printed data are filtered and adjusted as 384000 liquid-drops, there may be a slight difference in printed pattern details but ink capacity for both of the resolutions would be equivalent, resulting in equal film thicknesses. Filtering modes are shown in FIGS. 1A and 1B.

FIG. 1A shows three 4/9 filtering modes, in which 864000 liquid-drops are adjusted as 384000 liquid-drops for printing, so that 9 ink-jet points are filtered as 4 ink-jet points to be printed out at the same square measure. FIG. 1B shows other filtering modes. When the filtering is complete, the ink capacity printed can be effectively controlled by the filtering. When the printing data is filtered, however, certain detailed characteristics of the printed pattern are also filtered with obvious damages at the edge portions. The edge portions can be precisely rendered for high printing resolution to generate better printing results but the filtering would cause lower fineness for the edge portions.

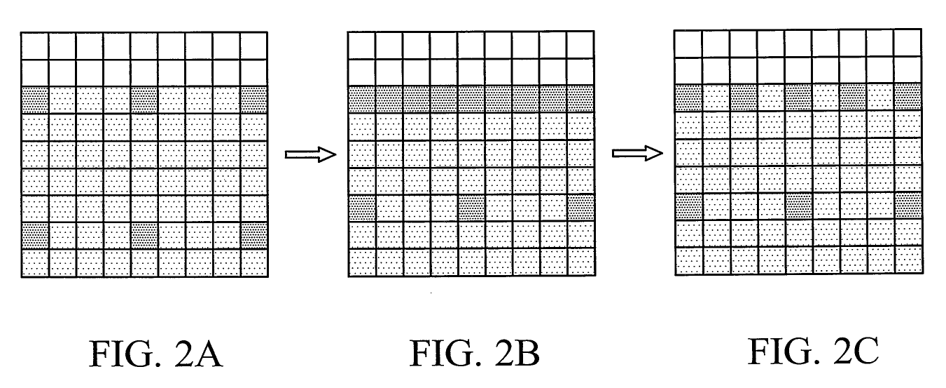

To solve the problem, an outline of a printed pattern is reserved before a filtering is preformed and is reverted when the filtering has been complete. As shown in FIG. 2A, the white portions represent non-printing locations of an original pattern, the gray portions represent the locations to be printed, and the black portions represent the remaining printing locations with the preformed filtering. Locations to be printed for the edge portions are reduced so that the printed resolution for the printing result is not up to standard. Thus, an edge reservation operation is performed, as shown in FIG. 2B, so that the edge portions are printed by the originally preset resolution to completely reserve characteristics of the edge. However, when the edge is completely reserved, there may be excessive printed ink capacity which overflows for a high resolution, such that the quality of the printing is negatively affected. Thus, a lesser filtering mode degree (in opposition to the original filtering mode) is applied for the reserved edge to clearly render the characteristics of the edge with minimum ink capacity, as shown in FIG. 2C.

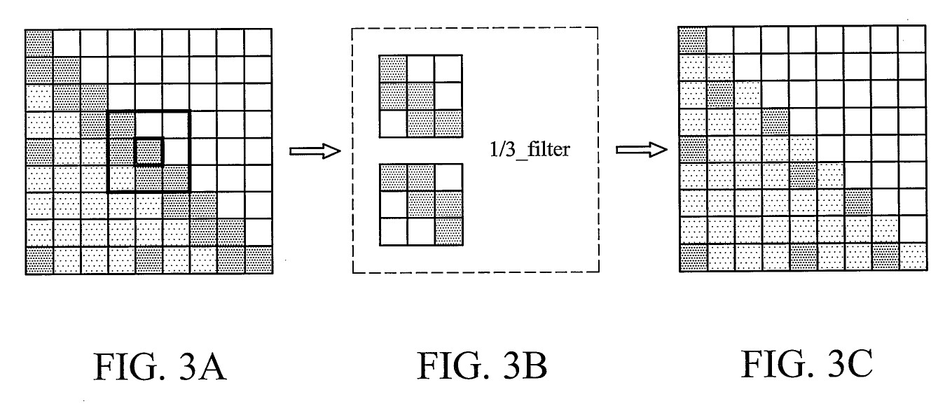

Edge filtering modes comprise various changes, applying different filtering modes based on different edge characteristics. A purpose of edge filtering is to reserve edge characteristics, thus representing the best edge characteristics is an important objective of the invention. Thus, characteristic recognitions for filtering modes of the edge are required to assign different filtering modes based on different characteristics or be directly replaced by pre-designed printing patterns. As shown in FIG. 3A, the two square frames therein represent items for determining characteristics and determining which two inner frames belongs to which edge characteristic according to the range circumscribed by the outer frame. As shown in FIG. 3B, when the edge of the pattern is recognized, two patterns involved therein are identified as left-top to right-bottom oblique lines, thus an edge filtering mode for an oblique line should be applied, and ink-jet points identified as edge characteristics for an oblique line are filtered using the 1/3 filtering mode, resulting in the filtering results shown in FIG. 3C.

As described, edge characteristics of a pattern are determined by a grid with 3×3 sizes and an X-Y coordinate system and are filtered using a filtering mode. An edge of a circular pattern, however, is filtered based on two dimensions of the X and Y coordinates that generate bad symmetry, so recognition and decoration for the circular pattern causes negative effects. The symmetry of the circular pattern can be reserved with filtered using an R-θ coordinate system. When image recognition is preformed, characteristics of the circular pattern can be found, the circular pattern is filtered using the R and θ coordinates, and the circular pattern is replaced to the original pattern.

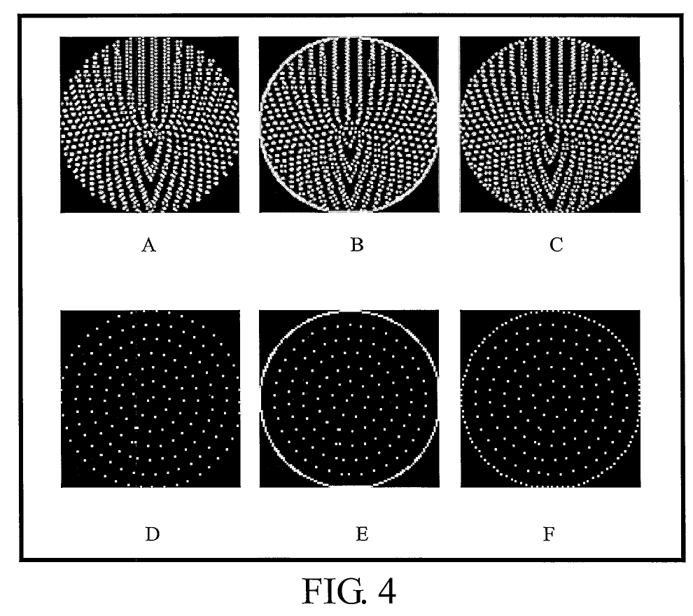

As shown by FIG. 4, the figure A illustrates one dimensional (representing an angle) filtering, the figure B illustrates one dimensional (angle) filtering plus an edge filtering, the figure C illustrates one dimensional (angle) filtering and an edge reservation plus an edge filtering, the figure D illustrates two dimensional (representing an angle plus a radius) filtering, the figure E illustrates two dimensional (representing an angle plus a radius) filtering plus an edge reservation, and the figure E illustrates two dimensional (representing an angle plus a radius) filtering and an edge reservation plus an edge filtering.

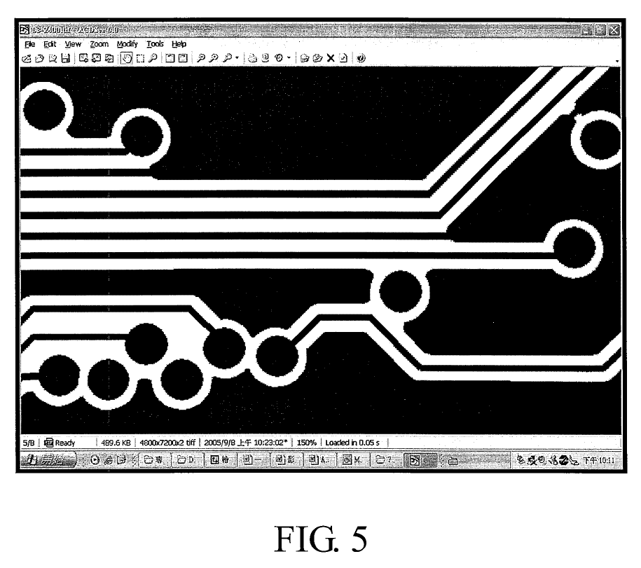

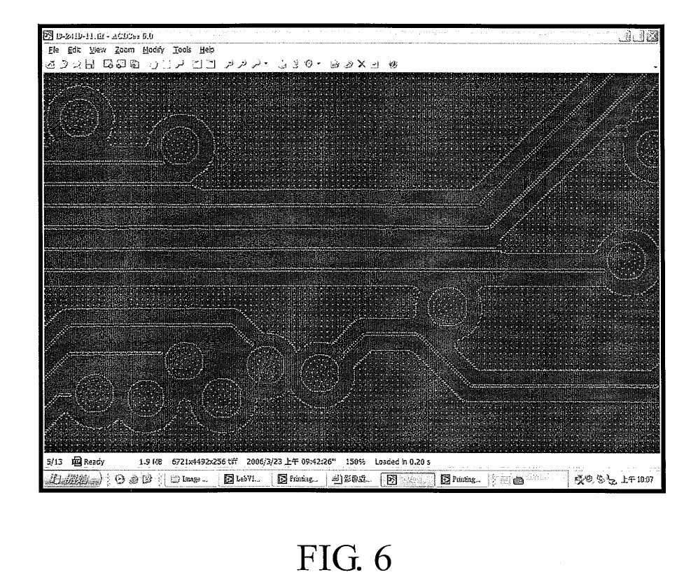

FIGS. 5 and 6 illustrate the original pattern and filtered results, respectively. The black portion in the FIG. 5 requires printing but the white portion does not. The FIG. 6 shows a decorated pattern, in which the red portion requires printing and the black portion does not require printing.

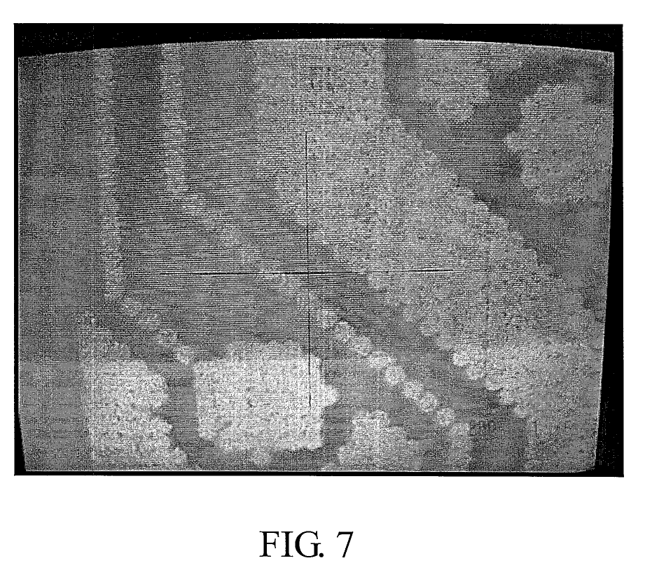

FIGS. 7-11 illustrate differences for different filtering modes based on experimental results. The experimental result is an electrolysis free copper plating process in which catalyst is added for printing and electrolysis free copper plating is performed to view printing results.

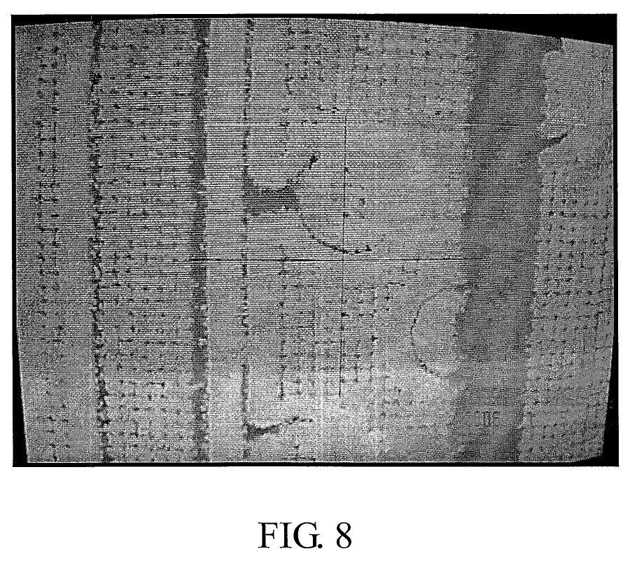

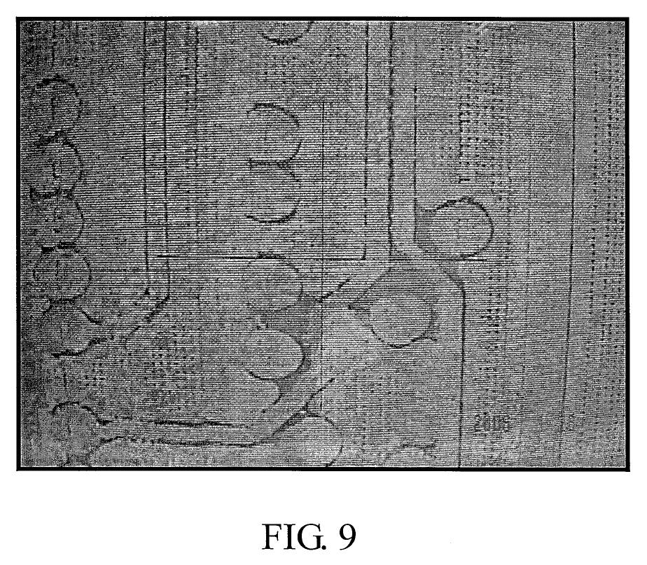

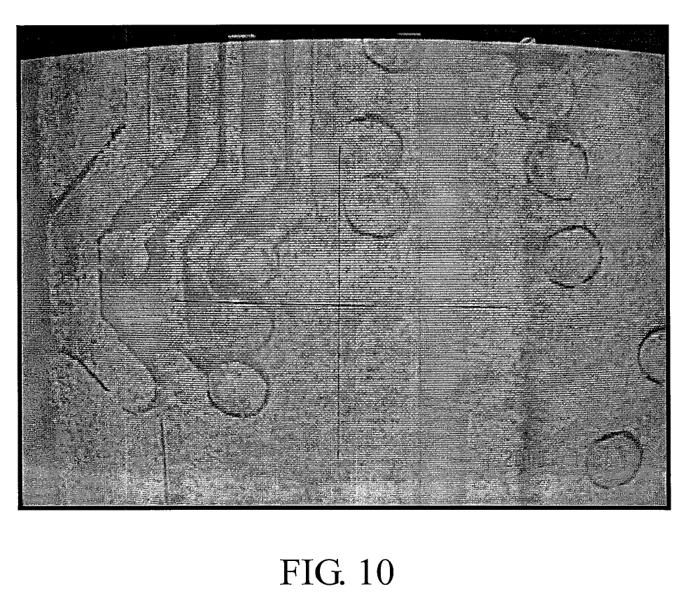

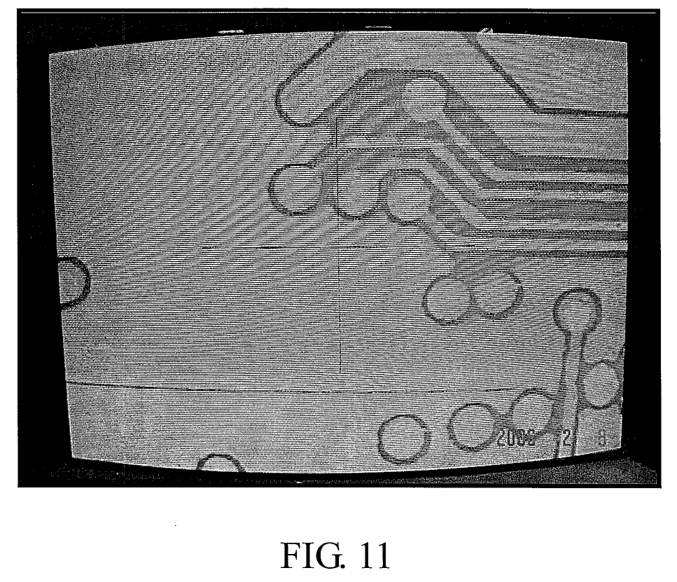

Applying a 1/25 filtering in the FIG. 7 results in a bad edge filtering results. Applying a 1/49 filtering plus an edge reservation in the FIG. 8 results in a greater gap than that shown in the FIG. 7. Additionally, the edge is completely reserved so that the ink capacity is large enough so as not to spread. Applying a 1/49 filtering plus a 1/2 edge filtering in the FIG. 9 results in more obvious gaps between a pad edge and a line edge than that in the FIG. 8. Applying a 1/25 filtering and a 1/2 edge filtering plus an edge filtering for oblique lines in the FIG. 10 results in line spacing of a bevel edge and no gaps for the filled portion due to applying of the 1/25 filtering. Applying a circle repair method for the circular pattern in the FIG. 11 results in an enhancement of the circular pattern.

Parameters used in the FIG. 11 are different from that in the FIGS. 7-10. Based on experimental results of the FIGS. 7-10, it can be recognized that there are obvious differences for controlled results of different filtering parameters. Filtering mode creation and parameter adjustment are implemented to the experimental results generated by different ink characteristics to achieve the optimum printing result. The filtering and adjusting results for the FIG. 11 can control the line width within 100 micrometers (um) and enable the output quality to be equivalent to the input pattern.

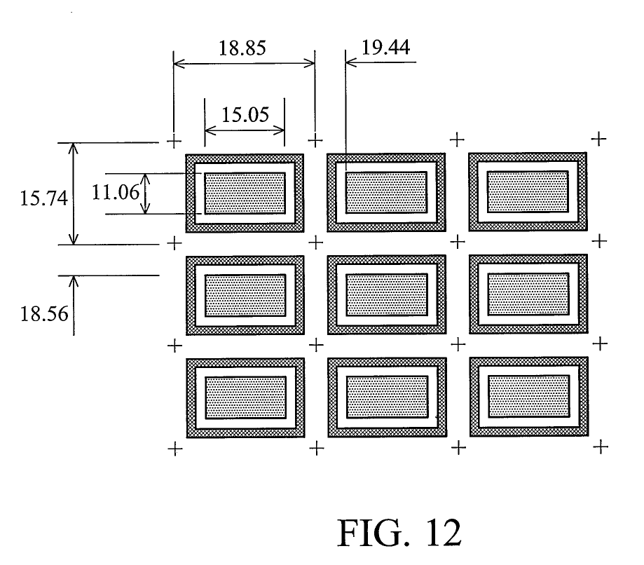

The filtering can also be applied to a liquid crystal coating. FIG. 12 illustrates an example of a liquid crystal coating area, achieving precise control of the amount of liquid crystal coating. As shown in FIG. 12, the yellow area represents a liquid crystal coating area with 15.05 mm×11.06 mm sizes in which the volume of the filler is 0.4839 mm3. The orange area represents frame rubber while the cross represents a scribe line and cross alignment symbol.

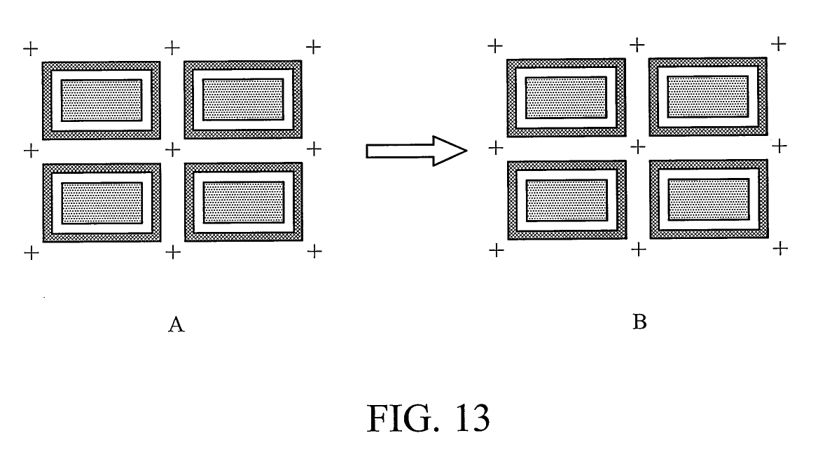

An error tolerance for a preset coating location has been considered in the coating area. Thus, with respect to a matrix coating area, a cell is generated and the number of liquid-drops thereof is controlled. 17057 liquid-drops are dripped in the cell with 13 mm (0.5118 inches)×9 mm (0.354 inches), as shown in figure A in FIG. 13. After calculated, 306.622 dpi is obtained for printing. For accuracy of the printing location, a rotational sprinkle-nozzle is not used for printing, thus the printing resolution is set by an integral multiple which exceeds 306.622 dpi and is closest to 50 dpi, i.e. 350 dpi.

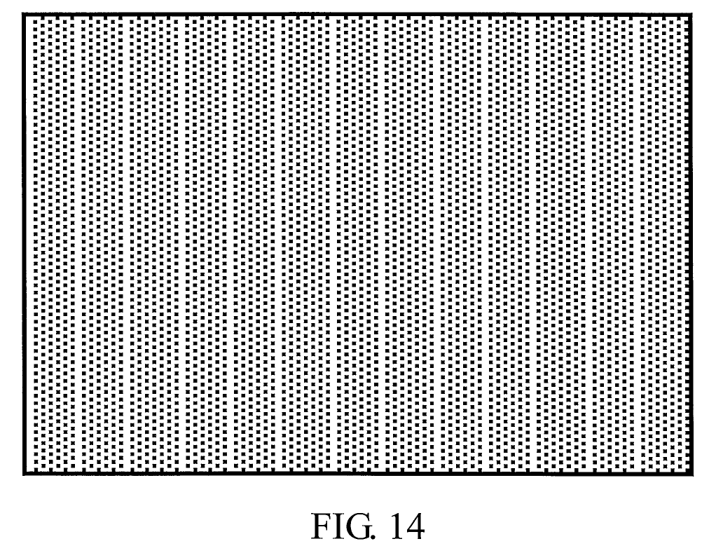

For such a resolution, as shown in figure B in the FIG. 13, 22196 liquid-drops are drilled in the 13 mm×9 mm pattern with 179×124 pixels. The number of filtered ink-jet points is then calculated, resulting in 5146 liquid-drops, which are averagely deducted from 22196 liquid-drops to generate a printing matrix for a single cell. The matrix is re-stuck on each preset locations, approaching corresponding distances relating to the rows and columns, thus completing the manufacturing of the printing pattern. FIG. 14 illustrates a resulting pattern by a program operation, in which data required for the operation is set as described.

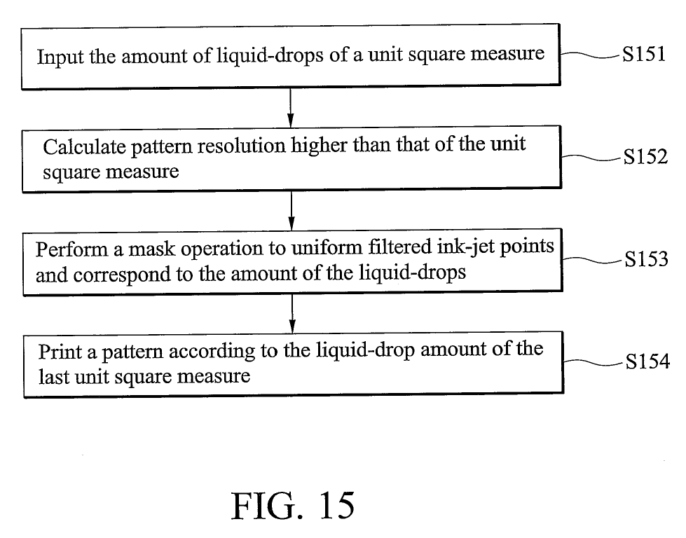

FIG. 15 is a flowchart of liquid crystal coating shown in FIGS. 12-14 of the present invention.

The amount of liquid-drops of a unit square measure is input (step S151) and pattern resolution higher than that of the unit square measure is calculated (step S152). A mask operation is performed to uniform filtered ink-jet points and correspond to the amount of the liquid-drops (step S153) and a pattern is printed according to the liquid-drop amount of the last unit square measure (step S154).

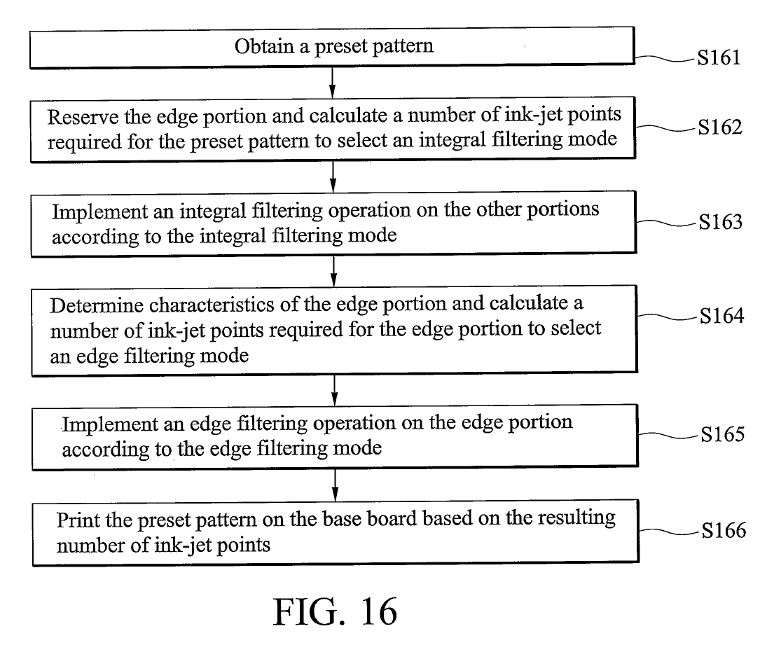

FIG. 16 is a flowchart of printing data calculation of the present invention.

A preset pattern is first obtained (step S161), comprising an edge portion and other portions. The edge portion is reserved and a number of ink-jet points required for the preset pattern are calculated to select an integral filtering mode (step S162). An integral filtering operation is implemented on the other portions according to the integral filtering mode, resulting in an applicable number of other portions (step S163). Characteristics of the edge portion are determined and a number of ink-jet points required for the edge portion are calculated to select an edge filtering mode (step S164). An edge filtering operation is implemented on the edge portion according to the edge filtering mode, resulting in an applicable number of the edge portion (step S165). The preset pattern is printed on the base board based on the resulting number of ink-jet points (step S166).

The integral filtering operation and the edge filtering operation relate to the preset pattern data content and the surface character information of the base board, which controls film thicknesses and the ink amount of a specified area to precisely and averagely control the ink-jet points, as shown in the FIG. 4. The filtering result relates to ink diffusion variation rates. The ink diffusion variation rates corresponding to different dot pitches can be calculated by transforming the surface character information of the base boar, as shown in the FIGS. 7-11. Partial data contents of the preset pattern are not printed out after the filtering operations are performed, as shown in FIGS. 1-3.

As described, the filtering operations can process pattern data comprising non-matrix curves using a R-θ coordinate system for a filtering process and, when the filtering process along the R and θ directions is complete, transform the filtering result to matrix pattern data. The R-θ coordinate system generates a pixel point by Δθ difference intervals along the θ direction, or by ΔR difference intervals along the R direction, and implements a filtering processing to the generated pixel point. The filtering process draws a pixel point by predetermined pixel point intervals which are not to be printed out. The 1-th, 4-th, 7-th, 11-th, . . . pixel points (or the 3-th, 6-th, 9-th, 12-th, . . . pixel points), for example, are drawn. Additionally, the filtering process can draw a pixel point by un-predetermined pixel point intervals which are not to be printed out. The 1-th, 3-th, 7-th, 10-th, . . . pixel points, for example, are drawn.

It is noted that an embodiment of the method for calculating ink-jet printing data improves a printing process which can be applied to a printing tool for manufacturing radio frequency identifications (RFID), color filters, polymer light-emitting devices (PLED), liquid crystal, conductive lines, layout text printing, photoresist printing, anti-welding coat printing, and so forth. The printing tool is composed of plural computing, determining, and processing units.

Methods and systems of the present disclosure, or certain aspects or portions of embodiments thereof, may take the form of a program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing embodiments of the disclosure. The methods and apparatus of the present disclosure may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for calculating ink-jet printing data, comprising:
obtaining a preset pattern;
calculating ink-jet points required for the preset pattern to select a filtering mode;
implementing a filtering operation on the preset pattern according to the filtering mode, resulting in an applicable number of ink-jet points for the preset pattern; and
printing the preset pattern on a base board based on the resulting number of ink-jet points.

2. The method for calculating ink-jet printing data as claimed in claim 1, wherein the preset pattern comprises an edge portion and other portions, further comprising:
reserving the edge portion and calculating a number of ink-jet points required for the preset pattern to select an integral filtering mode;
implementing an integral filtering operation on the other portions according to the integral filtering mode, resulting in an applicable number of other portions;
determining characteristics of the edge portion and calculating a number of ink-jet points required for the edge portion to select an edge filtering mode;
implementing an edge filtering operation on the edge portion according to the edge filtering mode, resulting in an applicable number of the edge portion; and
printing the preset pattern on the base board based on the resulting number of ink-jet points.

3. The method for calculating ink-jet printing data as claimed in claim 2, wherein the integral filtering operation and the edge filtering operation relate to data content of the preset pattern and surface character information of the base board.

4. The method for calculating ink-jet printing data as claimed in claim 3, wherein the filtering results relate to an ink-jet diffusion variation ratio for the printing operation and the surface character information of the base board is transformed to calculate ink-jet diffusion variation ratios corresponding to different dot pitches.

5. The method for calculating ink-jet printing data as claimed in claim 2, wherein a portion of the data content of the preset pattern is not printed out after the filtering operations are completed.

6. The method for calculating ink-jet printing data as claimed in claim 2, further comprising:
processing pattern data comprising non-matrix curves using a coordinate system implementing filtering using R and θ; and
after the R and θ directions of the coordinate system is processed by filtering, transforming the filtering result to matrix pattern data.

7. The method for calculating ink-jet printing data as claimed in claim 2, further comprising:
generating a pixel point for the preset pattern along the θ direction by Δθ difference intervals;
generating a pixel point for the preset pattern along the R direction by ΔR difference intervals; and
implementing the filter operation based on the generated pixel points.

8. The method for calculating ink-jet printing data as claimed in claim 2, wherein the filtering draws out a pixel point by fixed pixel point intervals and the drawn out pixel points are not printed out.

9. The method for calculating ink-jet printing data as claimed in claim 2, wherein the filtering draws out a pixel point by unfixed pixel point intervals from pixel points along a boundary of the preset pattern and the drawn out pixel points are not printed out.

10. A computer-readable storage medium storing a computer program providing a method for calculating ink-jet printing data, comprising using a computer to perform the steps of:
obtaining a preset pattern;
calculating ink-jet points required for the preset pattern to select a filtering mode;
implementing a filtering operation on the preset pattern according to the filtering mode, resulting in an applicable number of ink-jet points for the preset pattern; and
printing the preset pattern on a base board based on the resulting number of ink-jet points.

11. The computer-readable storage medium as claimed in claim 10, wherein the preset pattern comprises an edge portion and other portions, further comprising:
reserving the edge portion and calculating a number of ink-jet points required for the preset pattern to select an integral filtering mode;
implementing an integral filtering operation on the other portions according to the integral filtering mode, resulting in an applicable number of other portions;
determining characteristics of the edge portion and calculating a number of ink-jet points required for the edge portion to select an edge filtering mode;
implementing an edge filtering operation on the edge portion according to the edge filtering mode, resulting in an applicable number of the edge portion; and
printing the preset pattern on the base board based on the resulting number of ink-jet points.

12. The computer-readable storage medium as claimed in claim 11, wherein the integral filtering operation and the edge filtering operation relate to data content of the preset pattern and surface character information of the base board.

13. The computer-readable storage medium as claimed in claim 12, wherein the filtering results relate to an ink-jet diffusion variation ratio for the printing operation and the surface character information of the base board is transformed to calculate ink-jet diffusion variation ratios corresponding to different dot pitches.

14. The computer-readable storage medium as claimed in claim 11, wherein a portion of the data content of the preset pattern is not printed out after the filtering operations are completed.

15. The computer-readable storage medium as claimed in claim 11, further comprising:
processing pattern data comprising non-matrix curves using a coordinate system implementing filtering using R and θ; and
after the R and θ directions of the coordinate system is processed by filtering, transforming the filtering result to matrix pattern data.

16. The computer-readable storage medium as claimed in claim 11, further comprising:
generating a pixel point for the preset pattern along the θ direction by Δθ difference intervals;
generating a pixel point for the preset pattern along the R direction by ΔR difference intervals; and
implementing the filter operation based on the generated pixel points.

17. The computer-readable storage medium as claimed in claim 1, wherein the filtering draws out a pixel point by fixed pixel point intervals and the drawn out pixel points are not printed out.

18. The computer-readable storage medium as claimed in claim 1, wherein the filtering draws out a pixel point by unfixed pixel point intervals from pixel points along a boundary of the preset pattern and the drawn out pixel points are not printed out.
